(19) United States
(12) Patent Application Publication
(10) Pub. No.: US 2022/0138384 A1
(43) Pub. Date: May 5, 2022

(54) SYSTEM AND METHOD FOR COMPUTING QUALITY FACTOR OF MEMS MIRROR

(71) Applicant: BEIJING VOYAGER TECHNOLOGY CO., LTD., Beijing (CN)

(72) Inventors: Youmin Wang, Mountain View, CA (US); Yufeng Wang, Mountain View, CA (US); Gary Li, Mountain View, CA (US)

(73) Assignee: BEIJING VOYAGER TECHNOLOGY CO., LTD., Beijing (CN)

(21) Appl. No.: 17/090,788

(22) Filed: Nov. 5, 2020

(51) Int. Cl. G06F 30/28; G06F 30/23

(52) U.S. Cl. CPC G06F 30/28; G06F 2111/10; G06F 30/23

(57) ABSTRACT

Embodiments of the disclosure provide a method for designing an optical scanning mirror. The method may include receiving a first set of design parameters and a second set of design parameters of the scanning mirror. The method may include computing a first quality factor associated with slide film damping of the scanning mirror based on the first set of design parameters. The method may include computing a second quality factor associated with squeeze film damping of the scanning mirror based on the second set of design parameters using a simulation model. The method may include computing a third quality factor associated with the scanning mirror based on the first quality factor and the second quality factor. The method may include outputting the third quality factor associated with the scanning mirror.

### TECHNICAL FIELD

The present disclosure relates to designing scanning mirrors used in optical sensing systems, and more particularly to, a method for computing a quality factor (Qₜₒₜₐₗ) of the scanning mirror during the design phase for the scanning mirror, by computing a first quality factor (Q_{slide}) associated with slide film damping of the scanning mirror using a first technique and a second quality factor (Q_{squeeze}) associated with squeeze film damping of the scanning mirror using a second technique.

### BACKGROUND

Optical sensing systems, e.g., such as LiDAR systems, have been widely used in advanced navigation technologies, such as to aid autonomous driving or to generate high-definition maps. For example, a typical LiDAR system measures the distance to a target by illuminating the target with pulsed laser light beams and measuring the reflected pulses with a sensor. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

The LiDAR system may include a transmitter configured to emit a light beam to scan an object and a receiver configured to receive the light beam reflected by the object. The transmitter and the receiver may use optical components (e.g., a scanning mirror) to steer the light beam to a range of directions. A scanning mirror can be a single micro mirror, or an array of micro mirrors integrated into a micromachined mirror assembly made from semiconductor materials such as using microelectromechanical system (MEMS) technologies. In certain applications, a MEMS mirror may be operated with resonance. Using resonance may enable optical sensing systems to obtain large mirror deflection angles in a relatively small amount of time as compared to a non-resonating mirror. MEMS mirrors resonate at their characteristic oscillation frequencies, which are determined by their dimensions, e.g., such as their mass, structure, and spring constant, just to name a few.

The quality factor, (hereinafter, Q-factor), is a dimensionless parameter that describes the underdamping of a scanning mirror and may be used to estimate the maximum scanning angle of the MEMS mirror. Hence, being able to compute the Q-factor accurately and efficiently during the design phase of a MEMS mirror may be beneficial. Currently available techniques for computing the Q-factor during the design phase of a MEMS mirror requires an undesirable amount of time and computational resources, which makes these techniques very difficult to implement at best or impractical at worst.

Embodiments of the disclosure address the above problems by providing a method for computing the Q-factor that may use a reduced amount of time and computational resources as compared to the currently available techniques.

### SUMMARY

Embodiments of the disclosure provide a method for designing an optical scanning mirror. The method may include receiving, by a communication interface, a first set of design parameters and a second set of design parameters of the scanning mirror. The method may further include computing a first quality factor associated with slide film damping of the scanning mirror, by at least one processor, based on the first set of design parameters. The method may also include computing a second quality factor associated with squeeze film damping of the scanning mirror, by the at least one processor, based on the second set of design parameters using a simulation model. The method may additionally include computing a third quality factor associated with the scanning mirror, by the at least one processor, based on the first quality factor and the second quality factor. The method may include outputting, by the at least one processor, the third quality factor associated with the scanning mirror.

Embodiments of the disclosure also provide a system for designing an optical scanning mirror. The system may include a communication interface configured to receive a first set of design parameters and a second set of design parameters of the scanning mirror. The system may further include at least one processor. The at least one processor may be configured to compute a first quality factor associated with slide film damping of the scanning mirror based on the first set of design parameters. The at least one processor may be further configured to compute a second quality factor associated with squeeze film damping of the scanning mirror on the second set of design parameters using a simulation model. The at least one processor may be also configured to compute a third quality factor associated with the scanning mirror based on the first quality factor and the second quality factor. The at least one processor may be configured to output the third quality factor associated with the scanning mirror.

Embodiments of the disclosure further provide a non-transitory computer readable medium having instructions stored thereon that, when executed by one or more processors, causes the one or more processors to perform a method for designing an optical scanning mirror. The method may include receiving a first set of design parameters and a second set of design parameters of the scanning mirror. The method may further include computing a first quality factor associated with slide film damping of the scanning mirror based on the first set of design parameters. The method may also include computing a second quality factor associated with squeeze film damping of the scanning mirror based on the second set of design parameters using a simulation model. The method may additionally include computing a third quality factor associated with the scanning mirror based on the first quality factor and the second quality factor. The method may include outputting the third quality factor associated with the scanning mirror.

Embodiments of the disclosure provide a method for designing an optical scanning mirror. The method may include receiving, by a communication interface, a set of design parameters associated with the scanning mirror. The method may further include generating a parametric model of the scanning mirror and surrounding air, by at least one processor, based at least in part on the set of design parameters using a predetermined script. The method may also include computing a quality factor associated with the scanning mirror, by the at least one processor, by inputting the parametric model into a simulation model. The method may additionally include outputting, by the at least one processor, the quality factor associated with the scanning mirror.

Embodiments of the disclosure also provide a system for designing an optical scanning mirror. The system may include a communication interface configured to receive a first set of design parameters and a second set of design parameters of the scanning mirror. The system may further include at least one processor. The at least one processor may be configured to receive a set of design parameters associated with the scanning mirror. The at least one processor may be further configured to generate a parametric model of the scanning mirror and surrounding air based at least in part on the set of design parameters using a predetermined script. The at least one processor may be also configured to compute a quality factor associated with the scanning mirror by inputting the parametric model into a simulation model. The at least one processor may be additionally configured to output quality factor associated with the scanning mirror.

Embodiments of the disclosure further provide a non-transitory computer readable medium having instructions stored thereon that, when executed by one or more processors, causes the one or more processors to perform a method for designing an optical scanning mirror. The method may include receiving a set of design parameters associated with the scanning mirror. The method may further include generating a parametric model of the scanning mirror and surrounding air based at least in part on the set of design parameters using a predetermined script. The method may also include computing a quality factor associated with the scanning mirror by inputting the parametric model into a simulation model. The method may additionally include outputting the quality factor associated with the scanning mirror.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary LiDAR system, according to embodiments of the disclosure.

FIG. 2A illustrates a top view of an exemplary scanning mirror design, according to embodiments of the disclosure.

FIG. 2B illustrates a top view of another exemplary scanning mirror design, according to embodiments of the disclosure.

FIG. 3 illustrates a data flow for computing a Q-factor associated with squeeze film damping, according to embodiments of the disclosure.

FIG. 4A illustrates a first parametric model associated with a scanning mirror assembly, according to embodiments of the disclosure.

FIG. 4B illustrates a second parametric model associated with air surrounding the scanning mirror assembly, according to embodiments of the disclosure.

FIG. 5 illustrates an interface between air and a scanning mirror assembly, according to embodiments of the disclosure.

FIG. 6A illustrates a closed air boundary associated with a scanning mirror assembly, according to embodiments of the disclosure.

FIG. 6B illustrates an open air boundary associated with a scanning mirror assembly, according to embodiments of the disclosure.

FIG. 7 illustrates a block diagram of an exemplary system for designing a scanning mirror, according to embodiments of the disclosure.

FIG. 8 illustrates a flow chart of an exemplary method for designing scanning mirror, according to embodiments of the disclosure.

FIG. 9 illustrates a data flow diagram of an exemplary system for designing scanning mirror, according to embodiments of the disclosure.

FIG. 10 illustrates a flow chart of another exemplary method for designing scanning mirror, according to embodiments of the disclosure.

FIG. 11 illustrates a data flow diagram of another exemplary system for designing scanning mirror, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The scanning mirror is one part of an optical scanning systems. The scanning mirror performance directly affects the accuracy of point cloud and the image generated using the optical scanning system. One of the design parameters related to the scanning mirror performance is quality factor, (hereinafter, Q-factor). The Q-factor is related to the harmonic motion of a resonator, e.g., such as a resonating scanning mirror. More specifically, the Q-factor describes the underdamping, which is the energy dissipation (e.g., ΔE) with respect to time, of the scanning mirror.

The scanning angle, and, hence, the performance of the scanning mirror is directly affected by the Q-factor. For example, the maximum scanning angle of the scanning mirror at the resonant frequency θᵣ, can be estimated using Equation (1) below, where θₛ is the non-resonant scanning angle and Q is the Q-factor.

θᵣ≈Q·θₛ (1)

An example Q-factor range may be 100-1000. In some embodiments, a scanning mirror designed with a Q-factor of 525 may be desirable. While, in some other embodiments, a scanning mirror designed with a Q-factor of 725 may be desirable. Accordingly, being able to calculate the Q-factor with a high degree of accuracy and efficiency during the design phase for a scanning mirror may be crucial.

In a vacuum environment in which the scanning mirror does not experience damping, the Q-factor may be defined as the ratio of the scanning mirror's center frequency f₀ to its bandwidth Δf, as given by Equation (2) below.

$$Q = \frac{{f}_{0}}{Δ f} \qquad ( 2 )$$

However, the Q-factor calculation, for a scanning mirror in a non-vacuum environment, must take into consideration the effects of damping on harmonic motion if a high degree of accuracy is to be achieved.

Damping may occur when the freely moving scanning mirror is separated from the underlying substrate by a thin layer of air. When the scanning mirror resonates, flow occurs in the thin layer of air and the resulting energy dissipation produces damping. When the scanning mirror is driven using drive comb fingers, flow may also occur in the gaps between the drive comb fingers and the mirror, which may also cause damping. The damping of the scanning mirror includes both squeeze film damping and slide film damping.

In squeeze film damping, the scanning mirror moves so that the gap between scanning mirror and the substrate expands and/or contracts. When the gap contracts, the air film is squeezed between the scanning mirror and the substrate. In slide film damping, the scanning mirror moves parallel to structures such as drive comb fingers, leading to shearing within the air film. By dissipating energy from the moving scanning mirror, the air film results in a damping effect in both instances of squeeze and slide film damping. Squeeze film damping and slide film damping affect the harmonic motion of a scanning mirror, and, hence, they also affect the Q-factor of the scanning mirror.

For example, the governing equation of motion for a rigid body, e.g., such as a scanning mirror, is set forth below in Equation (3), where θ is mirror angle, J is mirror rotational moment of inertia, c_{squeeze} is damping coefficient primarily due to squeeze film effect from mirror, c_{slide} is damping coefficient primarily due to slide film effect from the drive combs, k is rotation spring constant, and M(t) is drive torque.

$$J \frac{{\partial }^{2} θ}{\partial {t}^{2}} + ( {c}_{squeeze} + {c}_{slide} ) \frac{\partial θ}{\partial t} + k θ = M ( t ) \qquad ( 3 )$$

The c_{squeeze} and c_{slide} may be used to compute, among other things, the Q-factor for the scanning mirror. Currently available techniques for solving c_{squeeze} and c_{slide} using Equation (3) involve a simulation model, e.g., such as a computational fluid dynamics (CFD) model. In certain implementations, c_{slide} may be associated with the drive comb fingers, and c_{squeeze} may be associated with the scanning mirror. The simulation model may simulate, e.g., the motion of a resonating scanning mirror assembly (e.g., scanning mirror, drive comb(s), anchor, torsion spring, substrate, etc.) and the air fluidity within the system. In order to solve the Navier-Stokes equations, which are a set of partial differential equations which describe the motion of air fluidity, the simulation model may use, e.g., a finite element analysis (FEA) method.

The FEA method subdivides the scanning mirror assembly (e.g., the scanning mirror, drive comb, anchors, substrate, etc.) into smaller, simpler parts, e.g., that are called finite elements. The subdivision of the scanning mirror system may be achieved by a particular space discretization in the space dimensions, which may be implemented by the construction of a mesh of the scanning mirror system: the numerical domain for the solution, which has a finite number of points.

For a scanning mirror assembly, due to the large scanning mirror size compared to the narrow air gaps associated with the drive comb fingers, different sized meshes may be used to simulating the fluidity in these different areas. For example, the narrow air gaps of the drive comb fingers may need a mesh with a higher resolution, and, hence, use a mesh with smaller finite element sizes. On the other hand, the scanning mirror mesh may be of lower resolution, i.e., finite elements of a larger size, in order to keep the simulation model from crashing due to the size of the scanning mirror in the overall simulation. The discrepancy in mesh resolutions between the mirror and drive comb areas poses computational challenges to the simulation.

Merging the drive comb mesh (e.g., first mesh with finite elements of a first size) with the scanning mirror mesh (e.g., second mesh with finite elements of a second size) may lead to crashes in simulation. For example, even if the scanning mirror mesh and the drive comb mesh can be merged together in the simulation model, the simulation may abort due to an inadequate mix and match of the drive comb mesh with finite elements of a first size and the scanning mirror mesh with finite elements of a second size. Therefore, computing c_{squeeze} and c_{slide}, and, hence, the Q-factor using the currently available techniques may be difficult or impractical.

The present disclosure provides a solution by separately computing a first quality factor (Q_{slide}) associated with slide film damping of the scanning mirror using a first technique and a second quality factor (Q_{squeeze}) associated with squeeze film damping of the scanning mirror using a second technique to determine the total quality factor (Qₜₒₜₐₗ) of the scanning mirror. The techniques provided herein may use significantly less time and computational resources in order to determine the Q-factor as compared to the currently available techniques.

Some exemplary embodiments are described below with reference to MEMS mirror(s) used in LiDAR system(s), but the techniques for computing the Q-factor are not limited thereto. Rather, one of ordinary skill would understand that the following description, embodiments, and techniques may apply to any type of scanning mirror and/or optical sensing system (e.g., biomedical imaging, 3D scanning, tracking and targeting, free-space optical communications (FSOC), and telecommunications, just to name a few) known in the art without departing from the scope of the present disclosure.

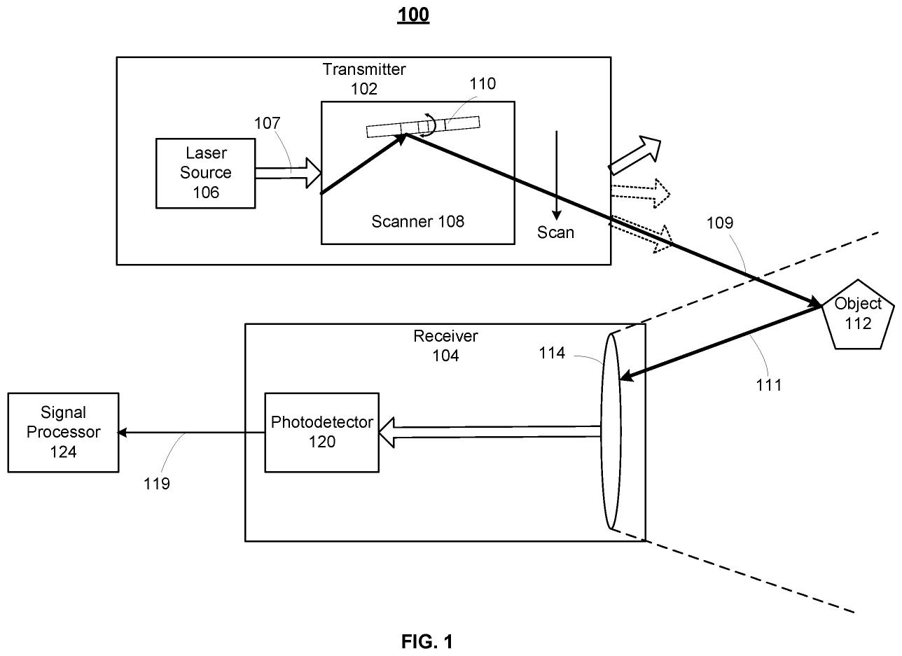

FIG. 1 illustrates a block diagram of an exemplary LiDAR system 100, according to embodiments of the disclosure. LiDAR system 100 may include a transmitter 102 and a receiver 104. Transmitter 102 may emit laser beams along multiple directions. Transmitter 102 may include one or more laser sources 106 and a scanner 108.

Transmitter 102 can sequentially emit a stream of pulsed laser beams in different directions within a scan range (e.g., a range in angular degrees), as illustrated in FIG. 1. Laser source 106 may be configured to provide a laser beam 107 (also referred to as “native laser beam”) to scanner 108. In some embodiments of the present disclosure, laser source 106 may generate a pulsed laser beam in the ultraviolet, visible, or near infrared wavelength range.

In some embodiments of the present disclosure, laser source 106 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 107 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, 848 nm, or 905 nm. It is understood that any suitable laser source may be used as laser source 106 for emitting laser beam 107.

Scanner 108 may be configured to emit a laser beam 109 to an object 112 in a direction within a range of scanning angles. In some embodiments consistent with the present disclosure, scanner 108 may include a micromachined mirror assembly having a scanning mirror, such as MEMS mirror 110. In some embodiments, at each time point during the scan, scanner 108 may emit laser beam 109 to object 112 in a direction within a range of scanning angles by rotating the micromachined mirror assembly. MEMS mirror 110, at its rotated angle, may deflect the laser beam 107 generated by laser sources 106 to the desired direction, which becomes laser beam 109. The micromachined mirror assembly may include various components that enable, among other things, the rotation of the MEMS mirror 110. For example, the micromachined mirror assembly may include, among other things, a scanning mirror (e.g., MEMS mirror 110), a first set of anchors, one or more actuators each coupled to an anchor in the first set of anchors, a second set of anchors, at least one spring coupled to at least one anchor in the set of anchors, and a substrate, just to name a few.

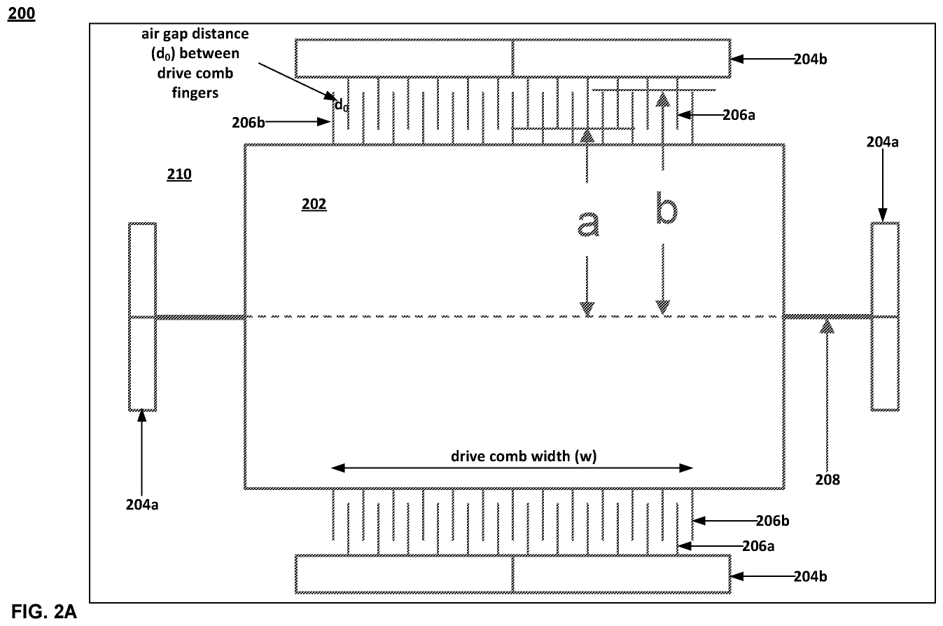

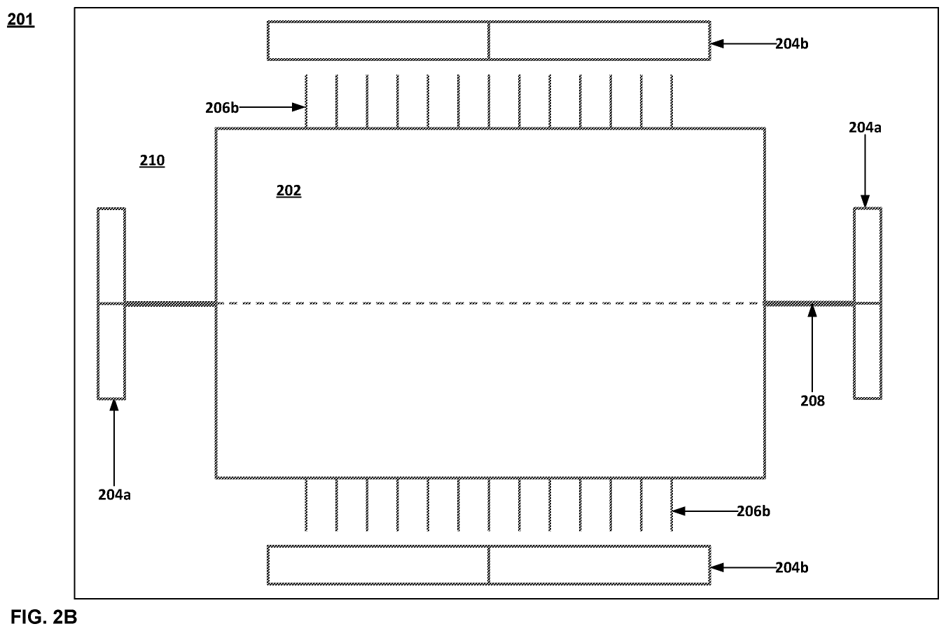

Certain design parameters of the MEMS mirror 110 may impact its scanning field of view (FOV). One such design parameter, as mentioned above, is the Q-factor. The Q-factor is proportional to the maximum scanning angle of a MEMS mirror 110. Thus, it may be beneficial to design a MEMS mirror with a Q-factor that may be tailored to a desired scanning FOV. The present disclosure provides a method that may enable a user to accurately and efficiently compute the Q-factor during the design phase of a MEMS mirror 110 in order to meet specific, e.g., LiDAR system requirements. Additional details associated with computing the Q-factor are set forth below in connection with FIGS. 2-11.

Object 112 may be made of a wide range of materials including, for example, non-metallic objects, rocks, rain, chemical compounds, aerosols, clouds and even single molecules. In some embodiments of the present disclosure, scanner 108 may also include optical components (e.g., lenses) that can focus pulsed laser light into a narrow laser beam to increase the scan resolution.

In some embodiments, receiver 104 may be configured to detect a returned laser beam 111 returned from object 112. The returned laser beam 111 may be in a different direction from beam 109. Receiver 104 can collect laser beams returned from object 112 and output electrical signals reflecting the intensity of the returned laser beams. Upon contact, laser light can be reflected by object 112 via backscattering, such as Rayleigh scattering, Mie scattering, Raman scattering, and fluorescence. As illustrated in FIG. 1, receiver 104 may include a lens 114 and a photodetector 120. Lens 114 may be configured to collect light from a respective direction in its FOV and converge the laser beam to focus before it is received on photodetector 120. At each time point during the scan, returned laser beam 111 may be collected by lens 114. Returned laser beam 111 may be returned from object 112 and have the same wavelength as laser beam 109.

Photodetector 120 may be configured to detect returned laser beam 111 returned from object 112. In some embodiments, photodetector 120 may convert the laser light (e.g., returned laser beam 111) collected by lens 114 into an electrical signal 119 (e.g., a current or a voltage signal). Electrical signal 119 may be generated when photons are absorbed in a photodiode included in photodetector 120. In some embodiments of the present disclosure, photodetector 120 may include a PIN detector, a PIN detector array, an avalanche photodiode (APD) detector, a APD detector array, a single photon avalanche diode (SPAD) detector, a SPAD detector array, a silicon photo multiplier (SiPM/MPCC) detector, a SiP/MPCC detector array, or the like.

LiDAR system 100 may also include one or more signal processor 124. Signal processor 124 may receive electrical signal 119 generated by photodetector 120. Signal processor 124 may process electrical signal 119 to determine, for example, distance information carried by electrical signal 119. Signal processor 124 may construct a point cloud based on the processed information. Signal processor 124 may include a microprocessor, a microcontroller, a central processing unit (CPU), a graphical processing unit (GPU), a digital signal processor (DSP), or other suitable data processing devices.

FIG. 2A illustrates a top view of an exemplary scanning mirror design 200, according to embodiments of the disclosure. Various aspects of the scanning mirror design 200 may be used (e.g., during the design phase) to calculate the slide film damping Q-factor (Q_{slide}) of a scanning mirror 202 (e.g., MEMS mirror 110).

For example, the scanning mirror design 200 may include a first set of design parameters that may be used to calculate Q_{slide}. In some embodiments, the first set of design parameters may be associated with one or more components of a scanning mirror assembly that would affect the slide film damping of the mirror. For example, the one or more components of the scanning mirror assembly affecting slide film damping may include, but are not limited to, a scanning mirror 202 (e.g., MEMS mirror 110), a first set of anchors 204a, a second set of anchors 204b, fixed drive comb fingers 206a coupled to anchor 204b, sliding drive comb fingers 206b coupled to the scanning mirror 202, a torsion spring 208, and/or a substrate 210, just to name a few.

In some embodiments, the first set of design parameters may be parameters of these components, and any change to these parameters may affect the slide film damping Q-factor. For example, the first set of design parameters may include dimensions (e.g., length, width, and thickness) of above components, e.g., dimensions of the scanning mirror 202 and dimensions of the drive comb, and distances between these components, e.g., the distance between the scanning mirror 202 and the anchors 204b. Other examples of the first set of design parameters may include one or more of the materials of these components, the natural frequency of the scanning mirror 202, air density, total overlap area for all drive comb fingers 206a, 206b, air gap spacing between components (e.g., the air gap between fixed drive comb fingers 206a and the sliding device comb fingers 206b), ambient pressure, operation frequency, air density, silicon density, moment of inertia of the scanning mirror, just to name a few.

In some embodiments, the slide film damping quality factor (Q_{slide}) associated with scanning mirror 202 may be calculated using the first set of design parameters and a first set of computations, e.g., Equations (4)-(7) set forth below. As illustrated in FIG. 2A, the aspect ratio of drive comb thickness (e.g., depth from the top of the drive comb to the substrate 210) over the drive comb air gap may be greater than 10. Therefore, the slide film damping (e.g., c_{slide}) caused by the drive comb fingers 206b sliding through 206a may be approximately computed as:

$${c}_{slide} = μ A β \frac{sinh ( 2 β {d}_{0} ) + sin ( 2 β {d}_{0} )}{cosh ( 2 β {d}_{0} ) - cos ( 2 β {d}_{0} )} , \qquad ( 4 )$$

where μ is viscous coefficient for the air, d₀ is air gap between two comb fingers, A is total overlap area between all comb fingers 206a and 206b, and β is a constant defined by:

$$β = \sqrt{\frac{{ω}_{n} ρ}{2 μ}} , \qquad ( 5 )$$

where ωₙ is the natural frequency of the scanning mirror 202 and ρ is air density. The slide damping ratio (ξ_{slide}) for the scanning mirror 202 may be calculated based at least in part on the slide film damping coefficient (c_{slide}) using Equation (6):

$${ξ}_{slide} = \frac{{c}_{slide}}{2 {ω}_{n}} \frac{{a}^{2} + a b + {b}^{2}}{3 \cdot J} , \qquad ( 6 )$$

where a and b are start and end positions of the overlap between drive comb fingers 206a and 206b as defined in FIG. 2A, ωₙ is the natural frequency of the scanning mirror 202. The slide film damping Q-factor (Q_{slide}) for the scanning mirror 202 may be calculated as:

Q_{slide}=1/(2ξ_{slide}) (7).

FIG. 2B illustrates a top view of another exemplary scanning mirror design 201, according to embodiments of the disclosure. Various aspects of the scanning mirror design 201 may be used (e.g., during the design phase) to calculate the squeeze film damping Q-factor (Q_{squeeze}) of a scanning mirror 202 (e.g., MEMS mirror 110).

For example, the scanning mirror design 201 may include a second set of design parameters that may be used to compute Q_{squeeze}. In some embodiments, second set of design parameters may be associated with one or more components of the scanning mirror assembly that affect the squeeze film damping of the mirror. While many of those components that affect the slide film damping may also affect squeeze film damping, some may not, such as the fixed drive comb fingers. Therefore, as seen in FIG. 2B, the second set of design parameters associated with scanning mirror design 201 may differ from the first set of design parameters associated with scanning mirror design 200 in FIG. 2A. For example, the one or more components of the scanning mirror assembly that may affect the squeeze film damping Q-factor may include one or more of, but are not limited to, a scanning mirror 202 (e.g., MEMS mirror 110), a first set of anchors 204a, a second set of anchors 204b, sliding drive comb fingers 206b coupled to the scanning mirror 202, a torsion spring 208, and/or a substrate 210, just to name a few. Because the squeeze film damping may not be affected by the fixed drive comb fingers (e.g., fixed drive comb fingers 206a seen in FIG. 2A), the second set of design parameters may not include parameters associated with them. Excluding parameters associated with the fixed drive comb fingers 206a, as in the present disclosure, may enable solution convergence in the simulation model since computations are based on a more uniformed mesh (e.g., scanning mirror mesh).

In some embodiments, the second set of design parameters may be parameters of these components, and any change to these parameters may affect the squeeze film damping Q-factor. For example, the second set of design parameters may include dimensions (e.g., length, width, and thickness) of above components, e.g., dimensions of the scanning mirror 202. Some other examples of the second set of design parameters may include, e.g., dimensions of one or more of the sliding drive comb fingers 206b, gimbal (not shown), spring 208, anchors 204a, anchors 204b, just to name a few. Some other examples of the second set of design parameters may include the distance between the scanning mirror 202 and the anchors 204b. Still other examples of the second set of design parameters may include one or more of the materials of these components, the natural frequency of the scanning mirror 202, air density, ambient pressure, operation frequency, silicon density, moment of inertia of the scanning mirror 202, just to name a few.

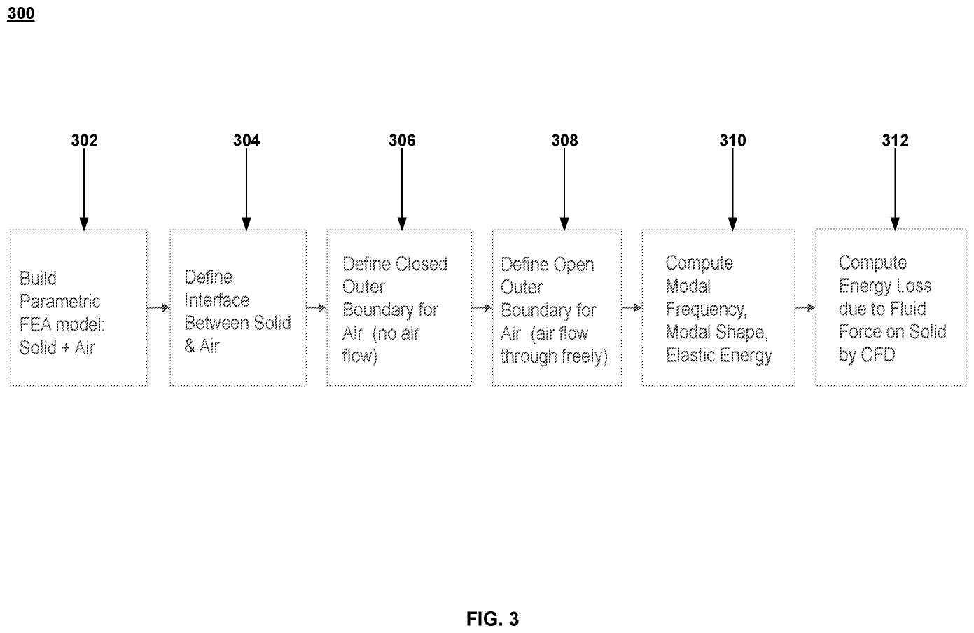

Additional details associated with computing Q_{squeeze} using the second set of parameters associated with the scanning mirror design 201 in FIG. 2B are described below in connection with FIG. 3.

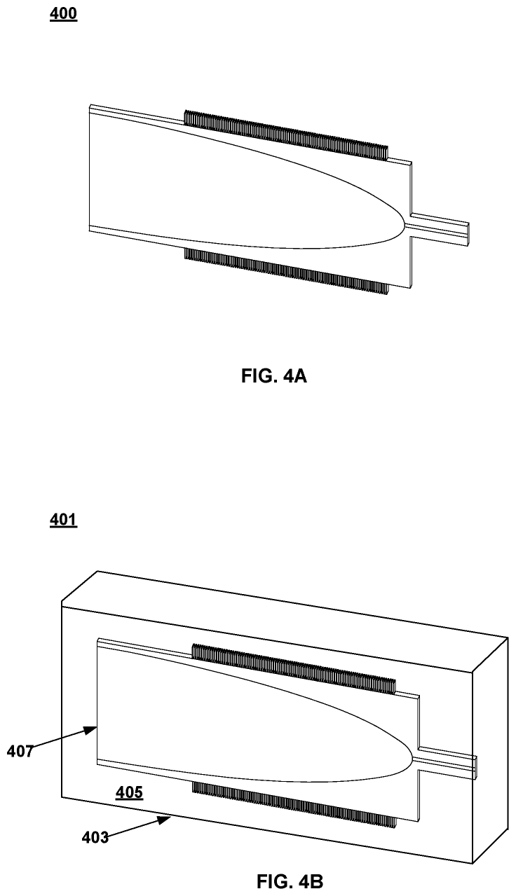

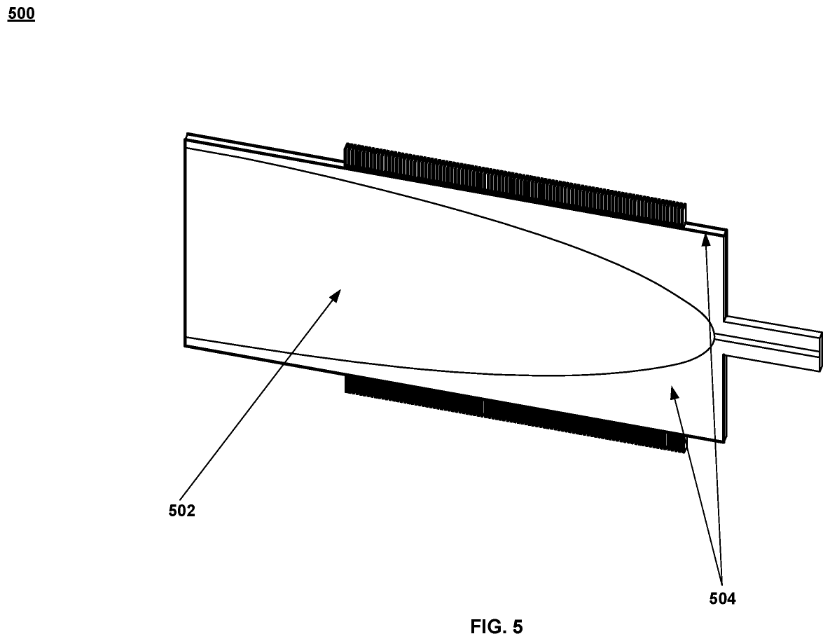

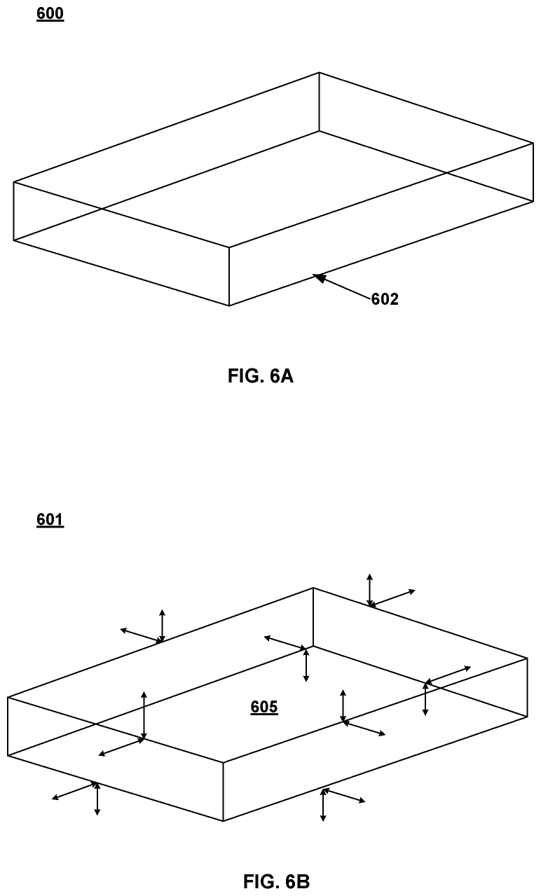

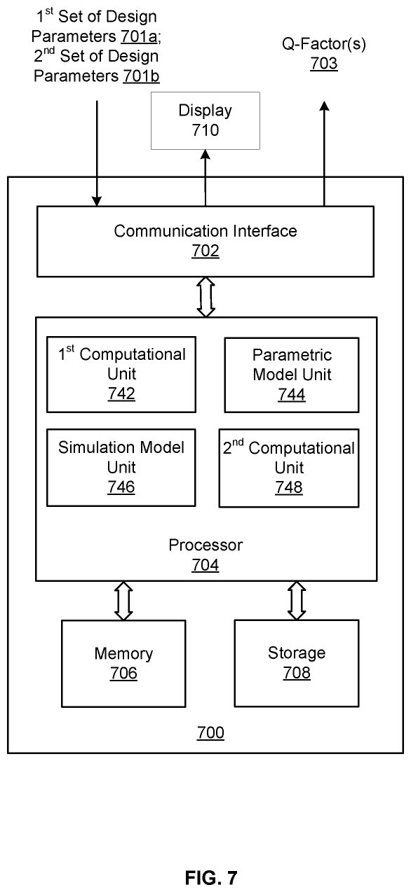

FIG. 3 illustrates a data flow 300 for computing Q_{squeeze}, according to embodiments of the disclosure. In some embodiments, the data flow 300 may be associated with a simulation model. The operations of data flow 300 may be performed by at least one processor, e.g., processor 704 illustrated in FIG. 7. The operations of data flow 300 may begin when a set of design parameters (e.g., the second set of design parameters described above in connection with FIG. 2B) are received. Certain operations in the data flow 300 of FIG. 3 are illustrated with additional detail in FIGS. 4A, 4B, 5, 6A, and 6B. For example, FIGS. 4A and 4B illustrate a first parametric model 400 associated with a scanning mirror assembly and a second parametric model 401 associated with air surrounding the scanning mirror assembly, respectively, according to embodiments of the disclosure. FIG. 5 illustrates an interface 500 between air and a scanning mirror assembly, according to embodiments of the disclosure. FIGS. 6A and 6B illustrate a closed air boundary 600 where there is no air flow and an open air boundary 601 where air can flow in and out, respectively, according to embodiments of the disclosure. FIGS. 3, 4A, 4B, 5, 6A, and 6B will be described together.

Referring to FIG. 3, operations 302, 304, 306, 308, 310 may be used to generate a parametric model (e.g., FEA model) of the scanning mirror and surrounding air. Operation 312 may apply simulation model (e.g., a CFD model) to the parametric model (e.g., FEA model) to compute information associated with the air flow and energy dissipation of the scanning mirror. In some embodiments, in terms of actual coding, the processor may implement operations 302, 304, 306, 308, 310 with a predetermined script, e.g., such as ANSYS simulation software and/or APDL, which is an ANSYS programming and development language used to generate an FEA model. On the other hand, the at least one processor may implement operation 312 with ANSYS CFX (e.g., a CFD model language). By using scripted modeling before inputting the parameters into the CFD model, operations of data flow 300 allow efficient adjustment of CFD parameters to reflect design changes that may occur during the mirror design phase.

At operation 302, the at least one processor may generate a parametric model associated with a scanning mirror assembly. The parametric model may be generated, e.g., using a set of design parameters that excludes parameters associated with fixed drive comb fingers (e.g., the second set of design parameters of FIG. 2B). The parametric model generated at 302 may include, e.g., the first parametric model 400 of FIG. 4A and the second parametric model 401 of FIG. 4B. As illustrated in FIG. 4A, the first parametric model 400 may be associated with the structure of a scanning mirror assembly designed with the second set of design parameters described above in connection with FIG. 2B. As illustrated in FIG. 4B, the second parametric model 401 may include a block 403 filled with air 405 with negative space 407 around the absent structure of scanning mirror assembly generated in the first parametric model 400.

At operation 304, the at least one processor may extract the interface between the solid structures of the scanning mirror assembly and the air. As illustrated in FIG. 5, the interface 500 extracted may include all moving surfaces 502 for scanning mirror along and all surfaces 504 for other components of the scanning mirror assembly, e.g., such as the gimbal, drive comb, torsion spring, just to name a few.

At operation 306, the at least one processor may define all the air outer surfaces where there is no air flow, e.g., against a solid wall. For example, the air enclosure 602 in FIG. 6A illustrates air outer surfaces where the at least one processor may define with no air flow.

At operation 308, the at least one processor may define all the air outer surfaces where the air is free to flow in and/or out. For example, the air enclosure 605 in FIG. 6B includes all outer surfaces where the air is exposed to ambient pressure and is free to flow in and/or out.

At operation 310, the at least one processor may compute modal shape and modal frequencies of various portions of the scanning mirror based at least in part on information obtained by the at least one processor by performing operations 302, 304, 306, 308. At operation 310, the at least one processor may compute total elastic energy (E) for the scanning mirror structure at the deformed shape for a specific frequency at which the scanning mirror operates. The at least one processor may generate a parametric model (e.g., FEA model) by performing operations 302, 304, 306, 308, and 310.

At operation 312, the at least one processor may apply a simulation model (e.g., CFD model) to the parametric model output by operation 310 (e.g., FEA model) to compute energy loss (ΔE) due to the force of air on the scanning mirror assembly over one period of harmonic oscillation. The simulation model may, among other things, treat air as the fluid being simulated, impose the modal harmonic motion on the inner air interfaces, apply boundary conditions on both closed and open surfaces, and specify integration parameters (e.g., step size, how many periods to simulate, etc.) in order to determine the scanning mirror's energy loss (ΔE) over one period.

Once the total energy (E) and the energy loss (ΔE) have been determined by applying the CFD model, the at least one processor may compute the squeeze damping ratio (ξ_{squeeze}) using Equation (8):

$${ξ}_{squeeze} = \frac{Δ E}{4 π E} . \qquad ( 8 )$$

The at least one processor may compute the squeeze film damping Q-factor (Q_{squeeze}) using Equation (9):

Q_{squeeze}=1/(2ξ_{squeeze}) (9).

Using the ξ_{slide} and ξ_{squeeze} computed above using Equations (6) and (8) respectively, the at least one processor may compute the total damping ratio (ξₜₒₜₐₗ) of the scanning mirror as:

ξₜₒₜₐₗ=ξ_{squeeze}+ξ_{slide} (10).

Using the Q_{slide} and Q_{squeeze} computed above using Equations (7) and (9) respectively, the at least one processor may compute the total damping ratio (Qₜₒₜₐₗ) for the scanning mirror as:

$${Q}_{total} = \frac{{Q}_{squeeze} \times {Q}_{slide}}{{Q}_{squeeze} + {Q}_{slide}} . \qquad ( 11 )$$

FIG. 7 illustrates a block diagram of an exemplary system 700 for designing a scanning mirror (e.g., MEMS mirror 110 of FIG. 1), according to embodiments of the disclosure. In some embodiments, as shown in FIG. 7, system 700 may include a communication interface 702, a processor 704, a memory 706, and a storage 708. In some embodiments, system 700 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of system 700 may be located in a cloud or may be alternatively in a single location (such as inside a mobile device) or distributed locations. Components of system 700 may be in an integrated device or distributed at different locations but communicate with each other through a network (not shown). Consistent with the present disclosure, system 700 may be configured to determine the design parameter values of the scanning mirror.

Communication interface 702 may send data to and receive data from databases via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 702 may include an integrated service digital network (ISDN) card, cable modem, satellite modem, or a modem to provide a data communication connection. As another example, communication interface 702 may include a local area network (LAN) card to provide a data communication connection to a compatible LAN. Wireless links can also be implemented by communication interface 702. In such an implementation, communication interface 702 can send and receive electrical, electromagnetic or optical signals that carry digital data streams representing various types of information.

Consistent with some embodiments, communication interface 702 may receive a first set of design parameters and a second set of design parameters of the scanning mirror from a database or a user input (not shown). Communication interface 702 may further provide the received data to memory 706 and/or storage 708 for storage or to processor 704 for processing.

Processor 704 may include any appropriate type of general-purpose or special-purpose microprocessor, digital signal processor, or microcontroller. Processor 704 may be configured as a separate processor module dedicated to determining design parameter values of the scanning mirror. Alternatively, processor 704 may be configured as a shared processor module for performing other functions in addition to determining design parameter values of the scanning mirror.

Memory 706 and storage 708 may include any appropriate type of mass storage provided to store any type of information that processor 704 may need to operate. Memory 706 and storage 708 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 706 and/or storage 708 may be configured to store one or more computer programs that may be executed by processor 704 to perform functions disclosed herein. For example, memory 706 and/or storage 708 may be configured to store program(s) that may be executed by processor 704 to determine design parameter values of the scanning mirror.

In some embodiments, memory 706 and/or storage 708 may also store various parametric models, FEA models, and/or CFD models, etc. Memory 706 and/or storage 708 may also store information associated with Equations (4)-(11) used to compute damping coefficients, damping ratios, and/or Q-factors, etc.

As shown in FIG. 7, processor 704 may include multiple modules, such as a first computational unit 742, a parametric model unit 744, a simulation model unit 746, a second computational unit 748, and the like. These modules (and any corresponding sub-modules or sub-units) can be hardware units (e.g., portions of an integrated circuit) of processor 704 designed for use with other components or software units implemented by processor 704 through executing at least part of a program. The program may be stored on a computer-readable medium, and when executed by processor 704, it may perform one or more functions. Although FIG. 7 shows units 742-748 all within one processor 704, it is contemplated that these units may be distributed among different processors located closely or remotely with each other. For example, units 742, 744, 748 may be part of an optimization device while unit 746 may be part of a separate simulation device. Additionally, unit 744 may be part of an optimization device while unit 746 may be part of a separate simulation device, and units 742 and 748 are part of a computational device.

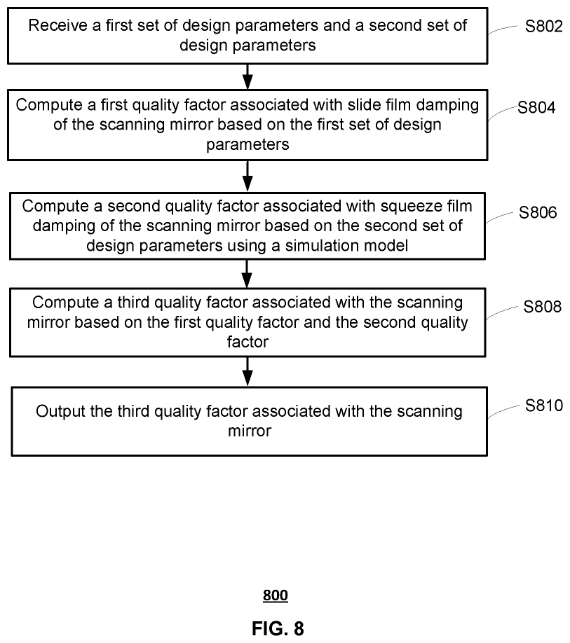

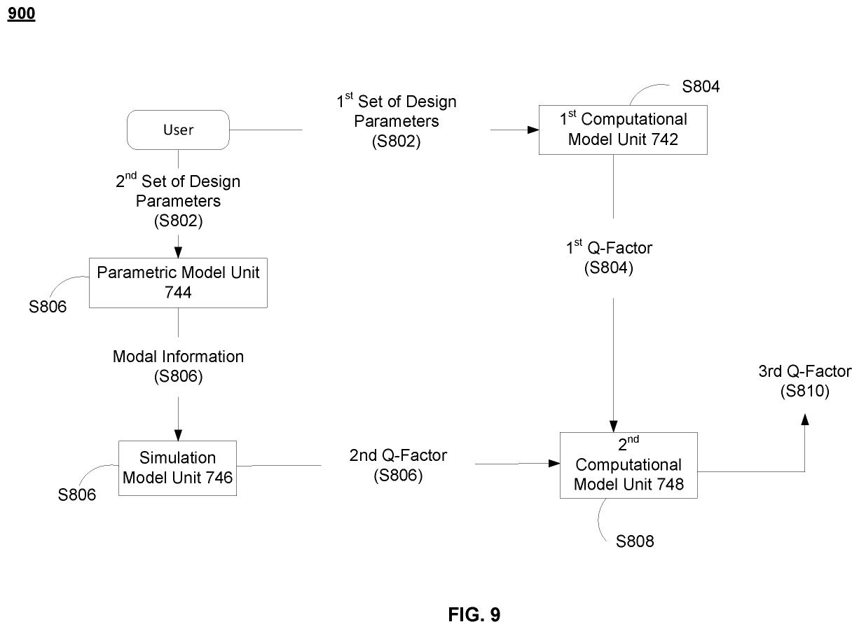

In some embodiments, units 742-748 of FIG. 7 may execute computer instructions to design a scanning mirror. FIG. 8 illustrates a flowchart of an exemplary method 800 for designing micro mirror arrays, according to embodiments of the disclosure. Method 800 may be performed by system 700 and particularly processor 704 or a separate processor not shown in FIG. 7. Method 800 may include steps S802-S810 as described below. It is to be appreciated that some of the steps may be optional, and some of the steps may be performed simultaneously, or in a different order than shown in FIG. 8. FIG. 9 illustrates a data flow diagram 900 of an exemplary system for designing micro mirror arrays, according to embodiments of the disclosure. FIGS. 7-9 will be described together.

In step S802, communication interface 702 may receive a first set of design parameters 701a (e.g., the first set of design parameters associated with scanning mirror design 200 of FIG. 2A) and a second set of design parameters 701b (e.g., the second set of design parameters associated with scanning mirror design 201 of FIG. 2B). In some embodiments, the second set of design parameters 701b may differ from the first set of design parameters 701a. For example, the second set of design parameters 701b may exclude parameters associated with the fixed drive comb fingers that may be included in the first set of design parameters 701a.

In step S804, first computational unit 742 may compute a first quality factor (e.g., Q_{slide}) associated with slide film damping of the scanning mirror based at least in part on the first set of design parameters 701a. In some embodiments, the first computational unit 742 may compute Q_{slide} by applying a first set of computations (e.g., Equations (4)-(7) described above) to the first set of design parameters 701a.

For example, the first computational unit 742 may compute Q_{slide} by computing a first damping coefficient (c_{slide}) based at least in part on the first set of design parameters 701a and a first formula. The first formula may include one or more of Equations (4) and/or (5) described above in connection with FIG. 2A. The first computational unit 742 may compute a first damping ratio (ξ_{slide}) based on the first damping coefficient (c_{slide}) and a second formula. The second formula may include at least in part Equation (6) described above in connection with FIG. 2B. Furthermore, the first computational unit 742 may compute Q_{slide} based at least in part on ξ_{slide} and Equation (7) described above in connection with FIG. 2A.

In step S806, the parametric model unit 744 and the simulation model unit 746 may compute a second quality factor (e.g., Q_{squeeze}) associated with squeeze film damping of the scanning mirror based on the second set of design parameters 701b. For example, the parametric model unit 744 may generate a parametric model of the scanning mirror and surrounding air based at least in part on the second set of design parameters 701b. The parametric model unit 744 may compute modal information using the parametric model. One or more of the parametric model and/or the modal information may be sent to the simulation model unit 746.

In some embodiments, the simulation model unit 746 may compute Q_{squeeze} based at least in part on the parametric model and modal information received from the parametric model unit 744 based on a simulation model. The simulation model may include, for example, a CFD model.

In some embodiments, the simulation model unit 746 may compute the energy loss (ΔE) over one period by applying a simulation model (e.g., CFD model) to one or more of the parametric model or modal information. In some embodiments, the simulation model unit 746 may compute a second damping ratio (ξ_{squeeze}) based at least in part on the energy loss (ΔE) over one period and a third formula. For example, the third formula may include at least in part Equation (8) described above in connection with FIG. 3. In some embodiments, simulation model unit 746 may compute Q_{squeeze} based at least in part on ξ_{squeeze} and a fourth formula. For example, the fourth formula may include at least in part Equation (9) described above in connection with FIG. 3.

In step S808, the second computational unit 748 may compute a third quality factor (e.g., Qₜₒₜₐₗ) associated with the scanning mirror based on the first quality factor (e.g., Q_{slide}) and the second quality factor (e.g., Q_{squeeze}). In some embodiments, the second computational unit 748 may compute Qₜₒₜₐₗ based at least in part on a fifth formula, Q_{slide}, and Q_{squeeze}. For example, the fifth formula may include at least in part Equation (11) described above in connection with FIG. 3.

In some alternative embodiments, the second computational unit 748 may compute a third damping ratio (e.g., ξₜₒₜₐₗ) associated with the scanning mirror based on the first damping ratio (e.g., ξ_{slide}), the second damping ratio (e.g., ξ_{squeeze}) and a sixth formula. For example, the sixth formula may include at least in part Equation (10) described above in connection with FIG. 3.

In step S810, the second computational unit 748 may output the third quality factor 703 associated with the scanning mirror to the communication interface 702. The communication interface 702 may output the third quality factor 703.

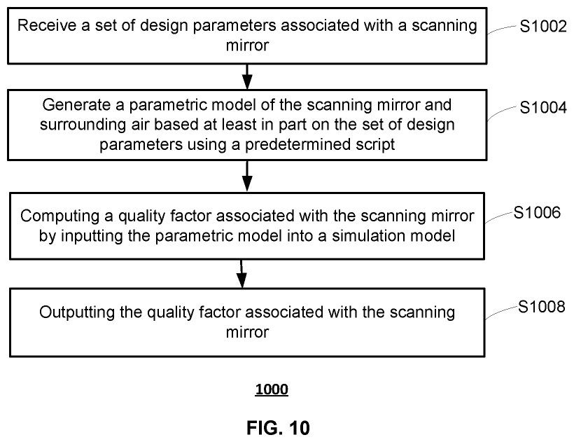

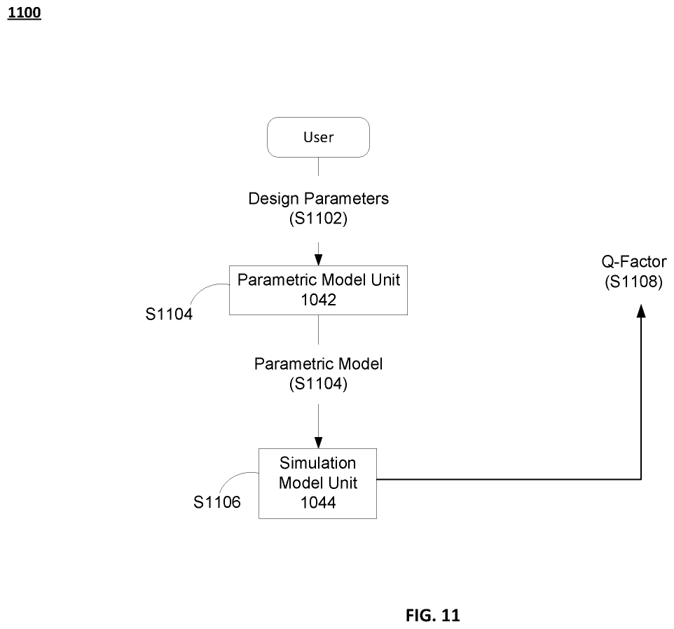

FIG. 10 illustrates a flowchart of an exemplary method 1000 for designing micro mirror arrays, according to embodiments of the disclosure. Method 1000 may be performed by system 700 and particularly processor 704 or a separate processor not shown in FIG. 7. Method 1000 may include steps S1002-S1008 as described below. It is to be appreciated that some of the steps may be optional, and some of the steps may be performed simultaneously, or in a different order than shown in FIG. 10. FIG. 11 illustrates a data flow diagram 1100 of an exemplary system for designing micro mirror arrays, according to embodiments of the disclosure. FIGS. 7, 10, and 11 will be described together below.

In step S1002, communication interface 702 may receive a set of design parameters 701b (e.g., the second set of design parameters associated with scanning mirror design 201 of FIG. 2B) of the scanning mirror. In some embodiments, the second set of design parameters 701b may exclude parameters associated with the fixed drive comb fingers that may be included in the first set of design parameters 701a. In certain alternative embodiments, the set of design parameters may include the first set of design parameters 701a. In the alternative embodiments, the processor 704 may remove any design parameters associated with fixed drive comb fingers to obtain the second set of design parameters.

In step S1004, the parametric model unit 744 may generate a parametric model of the scanning mirror and surrounding air based at least in part on the set of design parameters using a predetermined script. For example, the parametric model unit 744 may use a predetermined script, e.g., such as ANSYS simulation software and/or APDL, which is an ANSYS programming and development language to generate an FEA model. The parametric model unit may generate the parametric model of the scanning mirror and surrounding air based at least in part on implementing one or more of operations 302-310 described above in connection with FIG. 3.

In some embodiments, the parametric model unit 744 may generate a parametric model of the scanning mirror and surrounding air by defining an interface between the scanning mirror and the surrounding air and at least one outer boundary for the surrounding air, e.g., as described above in connection with operations 304-308 in FIG. 3.

In some embodiments, the parametric model unit 744 may generate a parametric model of the scanning mirror and surrounding air by computing at least one parameter associated with the parametric model based on the defined interface and at least one outer boundary, e.g., as described above in connection with operation 310 in FIG. 3.

In step S1006, the simulation model unit 746 may compute a quality factor associated with the scanning mirror by inputting the parametric model and modal information (e.g., the computed parameters) into a simulation model. In some embodiments, the simulation model unit 746 may compute the energy loss (ΔE) over one period by applying a CFD model to one or more of the parametric model or modal information. In some embodiments, the simulation model unit 746 may compute a second damping ratio (ξ_{squeeze}) based at least in part on the energy loss (ΔE) over one period and a third formula. For example, the third formula may include at least in part Equation (8) described above in connection with FIG. 3. In some embodiments, simulation model unit 746 may compute Q_{squeeze} based at least in part on ξ_{squeeze} and a fourth formula. For example, the fourth formula may include at least in part Equation (9) described above in connection with FIG. 3.

In step 1008, the simulation model unit 746 may output the quality factor (Q_{squeeze}) associated with the scanning mirror. In some embodiments, the simulation model unit 746 may output the Q_{squeeze} to the second computational unit 748. In some alternative embodiments, the simulation model unit 746 may output Q_{squeeze} to the communications interface 702.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A method for designing a scanning mirror for an optical sensing system, comprising:
receiving, by a communication interface, a first set of design parameters and a second set of design parameters of the scanning mirror;
computing a first quality factor associated with slide film damping of the scanning mirror, by at least one processor, based on the first set of design parameters;
computing a second quality factor associated with squeeze film damping of the scanning mirror, by the at least one processor, based on the second set of design parameters using a simulation model;
computing a third quality factor associated with the scanning mirror, by the at least one processor, based on the first quality factor and the second quality factor; and
outputting, by the at least one processor, the third quality factor associated with the scanning mirror.

2. The method of claim 1, wherein the simulation model is a computational fluid dynamics (CFD) model.

3. The method of claim 1, wherein the first set of design parameters comprises at least in part information related to drive comb fingers of the optical sensing system.

4. The method of claim 1, wherein the computing the first quality factor associated with the scanning mirror further comprises:
computing a first damping coefficient based on the first set of design parameters according to a first formula;
computing a first damping ratio based on the first damping coefficient according to a second formula; and
computing the first quality factor to be inversely proportional to the first damping ratio.

5. The method of claim 4, wherein the first damping coefficient comprises a slide-damping coefficient of the scanning mirror, and wherein the first damping ratio includes a slide-damping ratio of the scanning mirror.

6. The method of claim 1, wherein the computing the second quality factor of the scanning mirror further comprises:
generating a parametric model of the scanning mirror and surrounding air, by the at least one processor, based at least in part on the second set of design parameters; and
computing modal information using the parametric model.

7. The method of claim 6, wherein the computing the second quality factor of the scanning mirror further comprises:
computing an energy loss over one period based on the modal information using the simulation model;
computing a second damping ratio based at least in part on the energy loss computed using the simulation model; and
computing the second quality factor to be inversely proportional to the energy loss.

8. The method of claim 7, wherein the second damping ratio includes a squeeze-damping ratio of the scanning mirror.

9. A design system for an optical sensing system, comprising:
a communication interface configured to receive a first set of design parameters and a second set of design parameters of a scanning mirror; and
at least one processor, configured to:
compute a first quality factor associated with slide film damping of the scanning mirror based on the first set of design parameters;
compute a second quality factor associated with squeeze film damping of the scanning mirror based on the second set of design parameters using a simulation model;
compute a third quality factor associated with the scanning mirror on the first quality factor and the second quality factor; and
output the third quality factor associated with the scanning mirror.

10. The design system of claim 9, wherein the simulation model is a computational fluid dynamics (CFD) model.

11. The design system of claim 9, wherein the first set of design parameters comprises at least in part information related to drive comb fingers of the optical sensing system.

12. The design system of claim 9, wherein the at least one processor is configured to compute the first quality factor associated with the scanning mirror by:
computing a first damping coefficient based on the first set of design parameters according to a first formula;
computing a first damping ratio based on the first damping coefficient according to a second formula; and
computing the first quality factor to be inversely proportional to the first damping ratio.

13. The design system of claim 12, wherein the first damping coefficient comprises a slide-damping coefficient of the scanning mirror, and wherein the first damping ratio includes a slide-damping ratio of the scanning mirror.

14. The design system of claim 9, wherein the at least one processor is configured to compute the second quality factor of the scanning mirror by:
generating a parametric model of the scanning mirror and surrounding air, by the at least one processor, based at least in part on the second set of design parameters; and
computing modal information using the parametric model.

15. The design system of claim 14, wherein the at least one processor is further configured to compute the second quality factor of the scanning mirror by:
computing an energy loss over one period based on the modal information using the simulation model;
computing a second damping ratio based at least in part on the energy loss computed using the simulation model; and
computing the second quality factor to be inversely proportional to the energy loss.

16. The design system of claim 15, wherein the second damping ratio includes a squeeze-damping ratio of the scanning mirror.

17. A non-transitory computer-readable medium having stored thereon computer instructions, when executed by at least one processor, configured to perform a design method for a scanning mirror of an optical sensing system, the method comprises:
receiving a first set of design parameters and a second set of design parameters of the scanning mirror;
computing a first quality factor associated with slide film damping of the scanning mirror based on the first set of design parameters;
computing a second quality factor associated with squeeze film damping of the scanning mirror based on the second set of design parameters using a simulation model;
computing a third quality factor associated with the scanning mirror based on the first quality factor and the second quality factor; and
outputting the third quality factor associated with the scanning mirror.

18. The non-transitory computer-readable medium of claim 17, wherein the simulation model is a computational fluid dynamics (CFD) model.

19. The non-transitory computer-readable medium of claim 17, wherein the first set of design parameters comprises at least in part information related to drive comb fingers of the optical sensing system.

20. The non-transitory computer-readable medium of claim 17, wherein the computing the second quality factor of the scanning mirror further comprises:
generating a parametric model of the scanning mirror and surrounding air based at least in part on the second set of design parameters; and
computing modal information using the parametric model.
